(19) United States
(12) Patent Application Publication
(10) Pub. No.: US 2012/0073415 A1
(43) Pub. Date: Mar. 29, 2012

(54) Method For Slicing A Block Of Food Into Portions Of Precise Weight

(76) Inventors: Rainer Maidel, Durach (DE); Silvio Quaglia, Milano (IT)

(21) Appl. No.: 13/262,504

(22) PCT Filed: Apr. 6, 2010
(86) PCT No.: PCT/EP10/02149

§ 371 Date: Dec. 19, 2011

(30) Foreign Application Priority Data
Apr. 3, 2009 (DE) 10 2009 016 096.5
Dec. 23, 2009 (DE) 10 2009 060 536.3

(51) Int. Cl. B26D 5/20; B26D 7/30; A23L 1/00; A23P 1/00; B26D 7/06; B26D 5/00

(52) U.S. Cl. 83/13; 83/401; 83/76.1; 426/531

(57) ABSTRACT

The invention relates to a method for slicing a block of food (1) into portions (3) of precise weight. The invention further relates to a slicing machine (12) and to a block of food (1).

The present invention relates to a method for slicing a block of food into portions of precise weight. Furthermore, the present invention relates to a slicing machine and to a block of food.

Block of foods, for example blocks of sausage, cheese and/or ham often need to be sliced into portions which comprise at least one, preferably a plurality of, food slice(s) in order to sell them. This slicing is usually done on what are known as slicers, in which the respective block of food rests on a support which transports it continuously or intermittently in the direction of a cutting knife which takes off food slices from the front end of the block of food. The thickness of the respective slice is preferably determined by the speed of the advance in relation to the speed of the cutting knife. The slice(s) cut off is/are transported away in portions, with the weight of the packages needing to correspond to the prepacked goods regulations. This means that the packages need, particularly on average, to be provided with a greater weight than the indicated minimum weight. This additional weight is known to a person skilled in the art as “giveaway”, for example, and is undesirable or needs to be kept as minimal as possible, because it restricts the profitability of food production.

It was therefore the object of the present invention to provide a method and an apparatus in which this “giveaway” per portion is as low as possible.

The object is achieved by means of a method for slicing a block of food into portions of precise weight, in which:
the weight (W) or the length (L) of the block of food (1) is ascertained,
an irradiation scanner ascertains n signals (p_{i,i=1-n}) from n scan slices having a thickness (x_{i,i=1-n}) which are arranged in succession along the longitudinal axis (x) of the block of food,
the signals (p_{i,i=1-n}) are stored in a computer unit and the sum thereof (P) is formed and stored,
the values of W, P and p_{i,i=1-n} or L, P and p_{i,i=1-n} and also the desired target weight G of the respective portion are used to calculate the respective length to be taken off (x_{N}) from the block of food, and
this length is transferred to a slicing machine which cuts off the respective portion.

A block of food is preferably a block of sausage, cheese or ham. These block of foods often have an essentially constant cross section. Normally, the block of foods, such as a sausage, are elongate, i.e. their cross section is substantially smaller than their length. Normally, food slices are taken off at right angles to the longitudinal axis. Alternatively, the block of food may be a natural ham.

According to one alternative, the method according to the invention involves the weight of the entire block of food before it is sliced being ascertained. This can be done using any scales which are familiar to a person skilled in the art. However, the ascertainment of the weight within the context of the invention is not limited to weighing. If the density is known, the weight can also be ascertained on the basis of data from the irradiation scanner by virtue of the latter providing data about the external shape of the product, for example. This weight W is transferred to a computer unit which stores the weight value. If the weight of the block of food is known, it can also be transferred to the computer unit directly, without prior weighing.

In a second alternative, it is sufficient to know the overall length of the product. This procedure gives satisfactory results particularly when the average density of the block of product is known. This may be known on the basis of existing data and/or the value of the average density can be updated time and again using backward regulation. This length can be measured or may be known, because it is always essentially constant, for example in the case of cheese.

In a further method step, the block of food is examined slice by slice using an irradiation scanner. This irradiation scanner, for example an X-ray scanner, has a radiation source and a sensor, for example a photosensitive sensor, which is situated on respective opposite sides of the periphery of the block of food. This sensor is a line scan camera, for example. The radiation source emits rays which enter on one side of the periphery of the block of food, penetrate the entire width of the block of food and are received on the opposite side by the sensor. This sensor measures the intensity of the received rays, which are attenuated when irradiating the block of food, the attenuation being dependent on the local nature of the block of food, for example the density thereof. The irradiation takes place over the entire width of the product. The irradiation scanner is preferably provided at a fixed location, and the block of food is transported, preferably along its longitudinal axis, by the irradiation scanner. In this case, the block of food is supported on a conveyor belt, for example, which is arranged between the radiation source and the sensor. The block of food is irradiated slice by slice, the slices preferably being arranged perpendicular to the longitudinal central axis of the block of food. The desired thickness of such a slice, which is subsequently called a “scan slice”, is dependent on the desired measurement precision. Preferably, the thickness of the scan slice is less than the food slice to be taken off from the block of food, however. Preferably, the thickness of the scan slice is ≦⅕, particularly preferably ≦ 1/10, of the thickness of the food slice which is actually cut off. Preferably, the thickness of each scan slice is the same. The irradiation scanner measures n values p_{i,i=1-n} from n scan slices, the respective value preferably being an integral over the width of the product for the portioning of precise weight. The respective values measured by the sensor are stored in the computer unit, preferably on the basis of their respective position in the longitudinal direction of the block of food. The computer unit can be provided in the irradiation scanner or in a downstream slicer or in another CPU. This storage can be produced as single values.

Preferably, however, the measured values set a curve and this curve is stored. As a further preference, it is also possible to interpolate between two respective values. The computer unit accordingly preferably indicates which measured value has been ascertained at which point along the longitudinal axis of the block of food. If a uniform scan slice thickness is not being used, the respective thickness of the scan slice additionally needs to be recorded and stored and taken into account when ascertaining the curve.

When a block of food has been scanned completely, the sum P of all the values ascertained by the sensor is formed. If the thickness of the scan slices is not uniform, it may be advantageous if a sum weighted with the slice thickness is formed. The sum is likewise stored.

Next, the block of food is transferred, in the same orientation as that in which it was examined, to a slicing machine which divides it into portions. For each portion, a particular length x_{N} needs to be taken off from the block of food, said length corresponding to the desired target weight G of the respective portion, wherein a portion comprises at least one, preferably a plurality of, food slice(s). The cuts by the slicing machine are made essentially parallel to the direction of irradiation of the irradiation scanner and are preferably arranged essentially perpendicular to the longitudinal central axis of the block of food. If this is not the case, a mathematical correction needs to be made to the respective data record.

Preferably, the starting position of the block of food during slicing corresponds as exactly as possible to the starting position during scanning so that the longitudinal coordinates stored during scanning match the longitudinal coordinates during slicing.

The values of W, P and p_{i,i=1-n} and also the desired target weight G of the respective portion are used to calculate the respective length to be taken off (x_{N}) from the block of food.

Preferably, this is done by first of all calculating a factor k by dividing the weight W of the block of food by the sum P of all the measured signals from the scan slices.

The factor k can then be used to convert the measured value p_{i,i=1-n} into the weight w_{i,i=1-n} of each scan slice. These values are added for each portion until the desired target weight G of the portion has been reached. On the basis of the number of added scan slices multiplied by the thickness of the scan slices, the computer unit knows what length x_{N} needs to be taken off from the block of food for the respective portion. This process is repeated for each portion until the block of food has been sliced. The respective values are transferred from the computer unit to the slicing machine, which is controlled on the basis of this value. A person skilled in the art will understand that the product length to be taken off per portion can also be calculated in a computer unit or another CPU associated with the slicer which receives data from the irradiation scanner and transmits data to the slicer.

Alternatively, it is also possible to calculate what number of measured values is needed per portion. The measured values pᵢ are then added for each portion until the desired number of measured values for the portion has been reached. On the basis of the number of added scan slices multiplied by the thickness of the scan slices, the computer unit knows what length x_{N} needs to be taken off from the block of food for the respective portion. This process is repeated for each portion until the block of food has been sliced. The respective values are transferred from the computer unit to the slicing machine, which is controlled on the basis of this value. A person skilled in the art will understand that the product length to be taken off per portion can also be calculated in a computer unit or another CPU associated with the slicer which receives data from the irradiation scanner and transmits data to the slicer.

In accordance with a further preferred embodiment, the measured values are connected to form a curve. In order to ascertain what length (x_{N}) needs to be taken off from the block of food for the respective portion, a plurality of integrals, in particular, are calculated beneath the curve. In this case, the desired weight of the respective portion is prescribed and the integral is used to ascertain what length (x_{N}) needs to be taken off from the block of food for this portion. With quite particular preference, the entire calculation takes place for all portions of a block of food before the block of food is sliced.

The length to be taken off from the block of food (x_{N}) can be sliced into a prescribed number of food slices. This then results in the thickness of the food slices which need to be taken off for the respective portion.

Alternatively, a particular thickness of the food slices is predetermined. The computer unit then calculates how many of these food slices per portion are taken off from the block of food.

If the scan slices all have the same thickness, it suffices to count the number of measured values ascertained per block of food. This sum is then divided by a measured length of the block of food, and this is used to ascertain the thickness of a scan slice. The thickness of a scan slice can alternatively be ascertained in any other manner with which a person skilled in the art is familiar.

Preferably, the irradiation scanner has a means of transport, preferably a conveyor belt, which is used to transport the block of food along the transmitter and receiver.

Preferably, the irradiation scanner has a means, preferably a detection means, which captures at least one point from the start of the block of food on the conveyor belt. The detection means may be arranged upstream or downstream of the irradiation scanner. This detection means preferably starts the irradiation scanner and/or the recording of the measured values by the irradiation scanner. The measured values are preferably captured on the basis of the longitudinal axis of the product. This requires knowledge of the movement of the block of food relative to the scanner and/or the movement of the scanner relative to the block of food. By way of example, the conveyor belt has an encoder which transmits the movement of the belt, particularly the travel of the belt, to a data capture unit and/or the conveyor belt moves at a constant, known speed of transport. In this case, the time is captured and integration allows the travel covered by the product to be ascertained. The values from the irradiation scanner and the travel covered by the block of food are stored as pairs of values or as a curve. It is also possible to calculate and preferably store an interpolation between two or more respective values. The means preferably also starts the capture of the relative movement between the scanner and the block of food and/or the conveyor belt. A person skilled in the art will understand that the irradiation scanner may also be mobile, whereas the product is stationary. In this case, it is necessary to capture the movement of the irradiation scanner.

Preferably, the interval of time and/or the travel covered by the product between capture by the detection means and arrival at the scan plane, which extends preferably perpendicular to the direction of transport of the block of food, is/are captured. In the case of products whose front end is planar and oriented perpendicular to the direction of transport, this interval/travel normally corresponds to the physical interval between the detection means and the scan plane. Particularly in the case of natural products, such as ham, this interval will usually differ from the physical interval, however. Preferably, this interval/travel is forwarded to the slicing machine or an appropriate control unit/CPU so that this value can be used to synchronize the measured values to the slicing process, particularly to the movement of the block of food within the slicing apparatus.

In one preferred embodiment of the present invention, a plurality of block of foods are at least intermittently irradiated simultaneously using an irradiation scanner. Preferably, the block of foods are situated next to one another and are scanned preferably along their longitudinal axis.

A further subject of the present invention of the present invention is therefore an irradiation scanner which can be used to irradiate a plurality of block of foods at least intermittently in parallel. Preferably, the scanner according to the invention has merely one means of transport, preferably a conveyor belt. Preferably, the irradiation scanner has only one transmitter and one receiver, the longitudinal axis of which extends preferably perpendicular to the longitudinal axis of the product to be scanned. Preferably, the length of the longitudinal axis of the transmitter and/or receiver corresponds essentially to the width of the means of transport. Preferably, the scanner has, for each block of food, a means, preferably a detection means, which captures the start of the respective block of food on the conveyor belt.

Preferably, for each block of food a reference point is ascertained and transmitted to a slicing machine and/or another control unit/CPU individually. This reference point may be different for each block of food.

With further preference, for each block of food the interval between the means and the reference point is ascertained and transferred to the slicer or to another control unit/CPU.

A further subject of the present invention is a slicing machine having a cutting knife which takes off food slices from the front end of a block of food, wherein the block of food is transported by a means of transport in the direction of the cutting knife, and said slicing machine has means which can be used to establish and track the position of the block of food on the conveyor belt in the direction of transport thereof.

The means of transport is preferably one or more conveyor belts, wherein the block of food is preferably supported on a conveyor belt and is, at least in sections, in guided and/or transported by a further conveyor belt which is situated above the block of food.

Preferably, this means comprises a sensor or a stop. The means can capture a starting point, a starting line or a starting face of the product. Both the line and the face may be curved. On the basis of these data, it is possible to determine the position of the product on the conveyor of the slicer. Furthermore, these data can be used to adapt/synchronize the longitudinal coordinates ascertained during scanning to the travel of the block of food in the slicing machine.

Preferably, the position of the block of food in the slicing machine is captured without the block of food being significantly lengthened or shortened in the process.

Preferably, the block of food is fixed in the slicing apparatus such that it can at most make a small relative movement in relation to the means of transport.

Preferably, the means of transport comprises an encoder, for example an incremental encoder, or a similar means, which can be used to capture the movement, particularly the travel covered by the conveyor belt, so that a controller knows at any time where the start of the product is located and/or what longitudinal section of the product is currently being sliced.

In one preferred embodiment of the present invention, the slicing machine comprises a plurality of means of transport. This allows a plurality of blocks of food to be sliced simultaneously. The means of transport can preferably be driven independently of one another and can therefore be operated at different speeds. Each means of transport preferably has a means which can be used to establish the movement thereof, particularly the travel covered thereby. This means may be an encoder, for example an incremental encoder, or another means. According to the invention, each means of transport is provided with a means which can be used to establish and track the position of the block of food on the respective means of transport in the direction of transport thereof.

Preferably, the means recognizes the start of the respective block of food. By way of example, the means is a sensor.

In another preferred embodiment, the means is a stop which is struck by the start of the block of food before the latter is sliced. As a result, the block of food is in a clearly defined starting position and its travel can be clearly tracked, for example using the encoder of the conveyor belt, as soon as the stop has been removed.

The means may capture a starting point, a starting line or a starting face of the product. Both the line and the face may be curved.

Preferably, each means in the slicing machine captures the start of the block of food in the same region as the means in the irradiation scanner. Preferably, the means is/are arranged at the same height above the means of transport. Preferably or with particular preference, the means is/are arranged at the same width coordinate, as a result of which they detect the start of the block of food at the same location as the means on the scanner.

In one preferred embodiment, the slicing machine according to the invention has a means, preferably for each means of transport, which can be used to establish the orientation of the block of food on the conveyor belt. This means may be the same means as is used to identify the start of the product. This means can establish whether the block has been put into the slicer in the correct orientation; that is to say whether the start of the block of food during scanning is also the start of the block of food during slicing and/or whether the block of food is also supported on the means of transport for the slicer by the same face as that by which it was also supported during scanning. This is advantageous for slicing the block of food into portions of precise weight and/or classifying the sliced food slices.

Preferably, the slicing machine has a means which can be used to individualize the respective block of food. This preferred embodiment allows the respective scan data record to be associated, in particular automatically, with the respective block of food. The slicing machine recognizes which block of food is involved and loads the associated data which are required for portioning the block of food into precise weights. By way of example, the block of food may have a transponder or a bar code which is read by the slicing machine. This means may be the same means as is used to identify the start of the product and/or as is used to establish the orientation of the product.

In another preferred embodiment, the travel of a block of food between the irradiation scanner and the slicing apparatus and/or within the slicing apparatus is tracked, preferably electronically. This can be done in the form of an electronic shift register, for example. This preferred embodiment has the advantage that each data record can be clearly associated with the respective block of food.

Preferably, the slicing machine has a controller which automatically associates a scan data record with the respective block of food. This ensures that the respective block of food is portioned into precise weights. This preferred embodiment is also advantageous when a plurality of blocks of food are sliced simultaneously. The user then does not need to pay attention to the order in which he puts the blocks of food into the slicing machine. The order in the irradiation scanner does not need to correspond to the order for slicing.

Preferably, the slicing machine has a gripper which grasps the block of food at its end which is remote from the slicing face and stabilizes the position of the block of food, particularly when the block of food has already largely been sliced. Preferably, the block of food is not grasped until the block of food has already begun to be sliced. Preferably, the block of food is moved and/or guided such that it does not compress the block of food when the end of the block of food is grasped and/or subsequently held. This preferred embodiment ensures that the longitudinal coordinates which are ascertained during scanning also match the longitudinal coordinates during slicing.

The data ascertained by the irradiation scanner can also be used to determine quality features. By way of example, these values can be used to ascertain the region of the starting and ending pieces of the block of food, in which the diameter of the slices is smaller. In addition, the data can be used to ascertain regions of the block of food with a very high fat content, with very large cavities (cheese) and/or with what are known as “blood spots”. These regions with a reduced quality can then be rejected and do not make it into the sliced portion. The rejection is likewise made on the basis of the measured data and appropriate control of the slicing machine. Furthermore, the irradiation allows recognition of foreign bodies in the block of food. Blocks of food with foreign bodies are sliced at least only in part so as not to damage the knife or because they are unsuitable as food.

This analysis is preferably made by means of image evaluation. This image evaluation analyzes preferably each scan slice over its entire width; that is to say transversely with respect to the direction of transport of the block of food. Preferably, the irradiation scanner or a connected CPU therefore has a piece of image recognition software. Preferably, the analysis is made on the basis of a comparison, i.e. the data within a scan slice, the data before two plurality of scan slices or the data from one or more scan slices and stored comparison data are compared with one another. This allows local alterations in structure, foreign bodies, to be recognized.

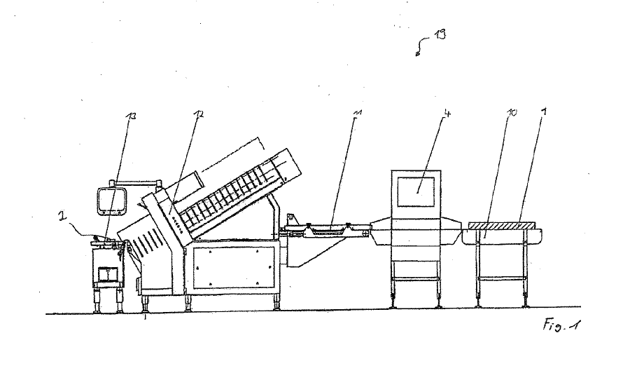

The invention is explained below with reference to three examples and FIGS. 1-9. These explanations are merely exemplary and do not restrict the general inventive concept. The explanations apply to all the subjects of the invention equally.

FIG. 1 shows a slicing line,

FIG. 2 shows the irradiation scanner,

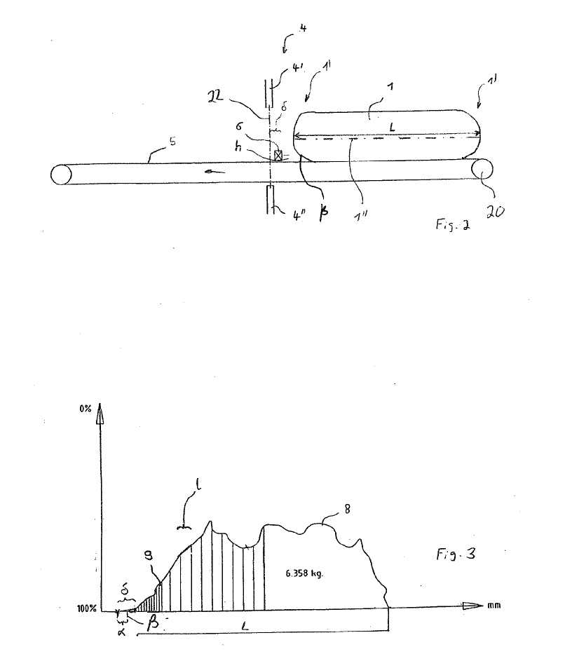

FIG. 3 shows the curve for the signal from the irradiation scanner,

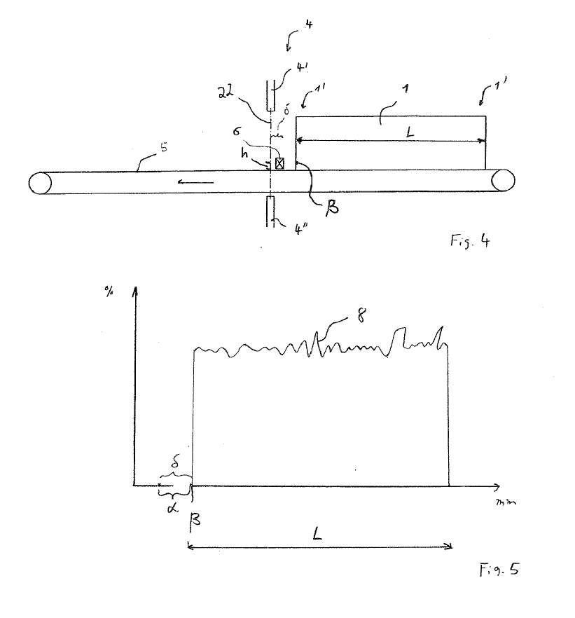

FIG. 4 shows the irradiation scanner,

FIG. 5 shows the curve for the signal from the irradiation scanner,

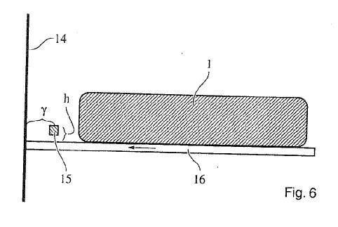

FIG. 6 shows the slicing machine according to the invention,

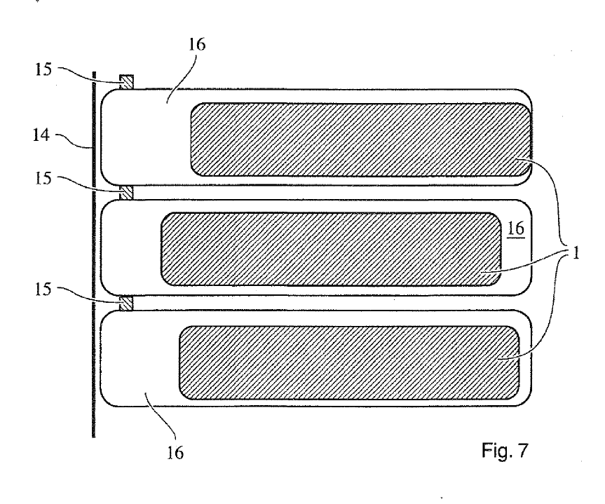

FIG. 7 shows a further embodiment of the slicing machine according to the invention,

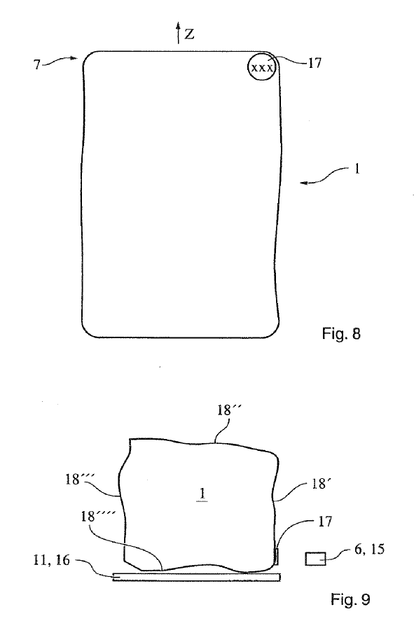

FIG. 8 shows the block of food according to the invention, and

FIG. 9 shows the block of food according to the invention on the irradiation scanner and the slicing machine.

FIG. 1 shows a slicing line in which blocks of food are sliced into food slices and this produces portions of precisest possible weight. A block of food 1 is conveyed through the irradiation scanner 4, preferably an X-ray scanner, by means of a supply belt. Before or after scanning, the block of food is weighed, for example by means of the scales 10. However, the weight of the respective block of food may also be known already. The scanner scans the product slice by slice. The performance of the scanning is explained in more detail with reference to FIGS. 2-5. When the block of food has been scanned, it is loaded into the slicer 12 by means of the supply conveyor belt 11. This supply belt can also comprise a buffer in which blocks of food which have already been scanned await slicing. The data ascertained by the irradiation scanner are transferred either directly to the slicing apparatus or to another control unit/CPU, where they are processed further as required. The slicing process in the slicing apparatus is then controlled using the data ascertained during scanning such that portions of precisest possible weight are produced. Furthermore, food slices whose structure has undesirable components are rejected and food slices of different quality are classified into different product groups. Following slicing, the respective food portions can be transferred to a weighing apparatus 13 in order to check whether the desired target weight has been observed. These data can be used to calibrate the data evaluation of the irradiation scanner and/or to control the slicing process. A person skilled in the art will recognize that the scanner may also be arranged within the slicing apparatus 12, for example in the region of the supply of product. The slicing apparatus can be used to slice a plurality of blocks of food simultaneously.

FIG. 2 shows an irradiation scanner which has a conveyor belt 5 which holds the block of food 1 that is to be analyzed. In the present case, said block of food is cylindrical, such as a salami, and has rounded ends 1′. By way of example, the conveyor belt 5 has a drive 20 with an encoder, as a result of which it is possible to establish the advance of the belt and/or the speed thereof at any time. If the conveyor belt is operated at a constant, known speed, this can also be used to ascertain the travel of the conveyor belt. The direction of transport of the conveyor belt is shown by the arrow. Furthermore, the irradiation scanner has a detection means 6, for example a photocell, which captures a point or a line β from the start of the product. The detection means 6 is arranged at an interval δ from the irradiation scanner 4. The detection means may be arranged upstream of downstream of the irradiation scanner. The irradiation scanner comprises a radiation source 4′ and a receiver 4″ which define a scan plane 22. The receiver 4″ is preferably a line scan camera, or any other means which can be used to analyze the block of food slice by slice.

The method according to the invention involves the weight of the entire block of food being ascertained as an option before the block of food is sliced. This can be done using any desired scales with which a person skilled in the art is familiar. The ascertainment of the weight within the context of the invention is not limited to weighing, however. If the density is known, the weight can also be ascertained on the basis of data from the irradiation scanner. This weight W is transferred to a computer unit which stores the weight value. If the weight of the block of food is known, it can also be transferred to the computer unit directly, without prior weighing. Alternatively, it may be sufficient to ascertain just the length of the block of food.

In a further method step, the block of food is examined slice by slice using an irradiation scanner. This irradiation scanner, for example an X-ray scanner, has a radiation source 4′ and a sensor 4″, for example a photosensitive sensor, which are located on respective opposite sides of the periphery of the block of food 1. The radiation source emits rays which enter on one side of the periphery of the block of food, penetrate the block of food and are received on the opposite side by the sensor. The block of food is irradiated over its entire width, which extends perpendicular to the plane of the paper. The sensor 4″ measures the intensity of the received rays, which are attenuated during irradiation of the block of food, the attenuation being dependent on the local nature of the block of food, for example the density thereof. Other parameters which can be ascertained using the irradiation scanner are described further below. The irradiation scanner is preferably provided in a fixed location, and the block of food is transported, preferably along its longitudinal axis, by the irradiation scanner. The block of food is irradiated slice by slice, the slices preferably being arranged perpendicular to the longitudinal central axis of the block of food. The desired thickness of such a slice, which is subsequently called a “scan slice”, is dependent on the desired measurement precision. Preferably, the thickness of the scan slice is less than the food slice which needs to be taken off from the block of food, however. Preferably, the thickness of the scan slice is ≦⅕, particularly preferably ≦ 1/10, of the thickness of the food slice which is actually cut off. Preferably, the thickness of each scan slice is the same. The irradiation scanner measures n values p_{i,i=1-n} from n scan slices. The respective values measured by the sensor are stored in the computer unit, quite particularly preferably as a measured value curve, preferably on the basis of their respective position in the longitudinal direction of the block of food. The computer unit may be associated with the irradiation scanner, with the slicing machine or with another control unit/CPU. The position of the scan values in the longitudinal direction is ascertained by the encoder on the conveyor belt. The computer unit accordingly indicates which measured value has been ascertained at what position along the longitudinal axis of the block of food. If a uniform scan slice thickness is not being used, it is additionally necessary to record and store the respective thickness of the scan slice. The scan values can be ascertained on the basis (as a function) of the thickness of the block of food. In order to portion the block of food with precise weights, however, it is normally sufficient if the measured scan values are integrated per scan slice over the thickness of the food product, i.e. one value per scan slice is sufficient.

Next, the block of food is transferred, in the same orientation as that in which it was also examined, to a slicing machine which divides it into portions. For each portion, a particular length 1 needs to be taken off from the block of food, said length corresponding to the desired target weight G of the respective portion, wherein a portion comprises at least one, preferably a plurality of, food slice(s). The cuts by the slicing machine are made essentially parallel to the direction of irradiation of the irradiation scanner and are preferably arranged essentially perpendicular to the longitudinal central axis of the block of food. If this is not the case, the scan values need to be mathematically corrected as appropriate. Preferably, the slicing machine likewise has a detector (c.f. FIGS. 6 and 7) which preferably ascertains the same reference point/line β from, the block of food as the detector 6 in the irradiation scanner. The signal from this detector is used to determine the position of the block of food in the slicing apparatus and/or to synchronize the data from the scan process exactly to the slicing process for the product.

The values ascertained by the irradiation scanner can additionally be used to determine quality features. By way of example, these values can be used to ascertain the region of the starting and ending pieces of the block of food in which the diameter of the slices is smaller. In addition, the data can be used to ascertain regions of the block of food with a very high fat content, with very large cavities (cheese) and/or with what are known as “blood spots”. These regions with a reduced quality can then be rejected and do not make it into the sliced portion. The rejection is likewise effected on the basis of the measured values and appropriate control of the slicing machine. Furthermore, the irradiation allows recognition of foreign bodies in the block of food. Blocks of food with foreign bodies are sliced at least only in part so as not to damage the knife or because they are unsuitable as food. In order to determine such quality features, the data ascertained for each scan slice are preferably analyzed as a function of the thickness (perpendicular to the plane of the paper), i.e. integral consideration for each scan slice is normally not sufficient in this case. This usually requires grayscale analysis, which is performed by a piece of image recognition software, for example.

The analysis of the ascertained data can result in a block of food being rejected as a whole or in part. The elimination of subregions in the block of food can be effected during or after slicing. The remainder can then be processed to produce “good portions”. The classification can also be performed during or after slicing. The classification is effected preferably using prescribed quality features.

FIG. 3 shows the signal from the irradiation scanner as a function of the signal from the encoder on the conveyor belt 4. If the conveyor belt is at a constant speed of transport, the signal can also be plotted as a function of time. On the basis of a travel/time interval of α, the travel/time difference between recognition of the start of the product by the X-ray scanner 4 and recognition of the reference point β by the detector 6, the scanner 4 first of all captures the starting region 1′ of the food 1. If the detector 6 is arranged downstream of the X-ray scanner, the scanner captures the starting region 1′ of the block of food 1 first before the detector 6 detects the block of food. In the case of a product in which the start of the product is planar and oriented perpendicular to the direction of transport, or if the detector incidentally captures the foremost tip of the product, α corresponds precisely to the interval δ between the detector 6 and the scanner 4. In the case of the product shown in FIG. 2, this will presumably not be the case. In this case, as shown, the situation will be α<δ, because the product tip precedes the reference point β. The value α is forwarded to the slicing machine and is used to synchronize the scan values to the movement of the block of food in the slicing machine. In particular, the reference point is used to make a back-calculation of the correct start of the product. Since the block of food is curved in the present case, the measured values increase slowly. For each scan slice 9, a value is ascertained on the basis of the position thereof within the block of food. The measured values are summarized as a curve 8. It is also possible for interpolation to take place between two or more measured values in each case. Each measured value in the curve represents an integral over the thickness and width of the respective scan slice. The scanner then captures the further structure of the block of food. The scan signal and the relative movement between the irradiation scanner and the block of food can be used to ascertain this length.

On the basis of the measured weight and/or the length L and the measured signals, the block of food is split into portions having a respective length 1 such that the respective desired weight of the portion is obtained. A person skilled in the art will recognize that this length 1 may be different for each portion.

FIG. 4 essentially shows the arrangement shown in FIG. 2, wherein the block of food in the present case has a perpendicularly arranged starting and ending region 1′. Accordingly, the measured signal shown in FIG. 5 has a very steep starting and ending edge. In this case, the reference point β coincides with the start of the product. In this case, α and δ are the same.

FIG. 6 shows the slicing machine according to the invention. Said machine has a means of transport 16 which is used to transport a block of food 1 in the direction of a rotating cutting knife 14. The means of transport preferably has an encoder which can be used to track the movement of the means of transport and hence of the block of food. This cutting knife 14 takes off food slices from the block of food, said food slices being configured to form portions comprising a plurality of food slices and then being transported away. The slicing machine according to the invention obtains the data ascertained by the irradiation scanner 4, as are shown in FIGS. 3 and 5, for example, in order to split the block of food into portions of precisest possible weight and in order to perform classification of the food slices. In order to synchronize the data transported by the scanner to the movement of the block of food in the slicing machine, the latter likewise has a detection means 15 which is at the interval γ from the cutting knife. As soon as this detection means detects the start of the block of food 1, the apparatus can calculate when the start of the block of food 1 will be in the cutting plane of the cutting knife 14 and can correlate this time to the data transported by the scanner. For this purpose, preferably the value α is transmitted to the slicing machine. It is important that the detection means 15 detects the same region/point β at the front end of the food as the detection means 6 in the irradiation scanner. Preferably, the two detection means 6, 15 are therefore arranged at the same height h, so that they recognize the block of food at the same height. If the detection is effected from above, the detection means 6, 15 need to be provided at the same width coordinate. An at least almost identical arrangement of the detection means 6, 15 ensures that the slicing and the associated data are exactly correlated. A person skilled in the art will recognize that the slicing machine can also have a stop against which the front end of the block of food bears, preferably without being compressed in the process. This clearly stipulates the position of the block of food in the slicing machine, and the further travel of said block of food can be clearly tracked. A control unit knows when the front end of the block of food will be in the cutting plane, and it will synchronize the ascertained scan data accordingly.

FIG. 7 shows a further embodiment of the slicing machine according to the invention. In the present case, a plurality of blocks of food 1 can be sliced simultaneously. For this purpose, the slicing machine according to the invention has a plurality of conveyor belts 16 which can be used to transport the blocks of food at respective different speeds in the direction of the cutting knife. In the cutting plane of the cutting knife 14, the blocks of food are sliced into food slices. In this case too, each means of transport 16 has an encoder which can be used to ascertain the advance of each means of transport in each case. Furthermore, each means of transport 16 has a detection means 15 which can be used to ascertain the start of the respective block of food. Otherwise, reference is made to the explanations relating to FIG. 6.

FIG. 8 shows the block of food according to the invention, which has at center 17 in its starting region. The direction of transport of the block of food is shown by the arrow denoted by “z”. This means may firstly be an orientation means which can be used to establish whether the start of the product 7 is actually arranged at the front in the direction of transport. Furthermore, the means 17 can be provided with a piece of information which allows identification at the respective block of food. This allows the respective data record to be associated with the respective block of food. This information can also be used to track the production, so that it is known which portion has been sliced from which block of food. The means 17 is preferably removed from the block of food before slicing.

As can be seen from FIG. 9, the means 17 also allows establishment of whether the block of food 1 is supported on the correct peripheral face, in this case the peripheral face 18″″, during scanning and/or during slicing. This may be important particularly if the block of food has an inner structure which needs to be recognized during scanning.

### EXAMPLE 1

1) The weight W of the block of food is ascertained (e.g.: 2000 g).

2) The block of food is transported through an X-ray scanner. The X-ray scanner takes a split shot of the block of food, e.g. every 0.1 mm. The width of the split is set by the speed at which the block of food passes through the X-ray scanner and/or the frequency of the shots, for example.

3) The X-ray scanner ascertains n=5000 data items, p_{i,i=1-n}, for example. The ascertained values p_{i,i=1-n} are dependent on the local X-ray absorption of the block of food and are p₁=83.234, p₂=83.334, p₃=83.244, for example. The values are stored individually and as a function of their position along the longitudinal axis of the block of food in a computer unit which is connected to the X-ray scanner.

4) All 5000 values are then added (e.g. 416325).

5) From this sum P and the weight W of the block of food, the weight factor k is ascertained 2000 g/416325=0.004805728.

6) This weight factor k can be used to calculate the weight of each scan value p_{i,i=1-n}, i.e. of each scan slice, e.g. w₁=83.234*K=0.399999 g. This is the weight w₁ of 0.1 mm product at the position i=1.

7) The target weight of the portion (e.g. 150 g) is taken as a basis for calculating the number of scan slices which need to be cut off from the block of food in order to obtain the target weight for this portion. For this, the weight values wᵢ are added until the desired target weight has at least been reached (e.g. 375 scan slices). This corresponds to a real product length of 37.5 mm which needs to be cut off from the block of food for this portion.

8) Assuming that the portion is intended to have 15 food slices in the present case, a food slice thickness of 2.5 mm is obtained.

9) Accordingly, the slicing machine will cut off 15 food slices having a thickness of 2.5 mm each from the block of food.

10) Steps 7-9 are repeated until the block of food has been sliced.

### EXAMPLE 2

1) The weight W of the block of food is ascertained (e.g.: 2000 g).

2) The block of food is transported through an X-ray scanner. The X-ray scanner takes a split shot of the block of food, e.g. every 0.1 mm. The width of the split is set by the speed at which the block of food passes through the X-ray scanner and/or the frequency of the shots, for example.

3) The X-ray scanner ascertains n=5000 data items, p_{i,i=1-n} for example. The ascertained values p_{i,i=1-n} are dependent on the local X-ray absorption of the block of food and are p₁=83.234, p₂=83.334, p₃=83.244, for example. The values are stored individually and as a function of their position along the longitudinal axis of the block of food in a computer unit which is connected to the X-ray scanner.

4) All 5000 values are then added (e.g. 416325).

5) The target weight of the portion (e.g. 150 g) is first of all taken as a basis for calculating what number of scan values corresponds to this weight=416325*150/2000. The number of scan slices which need to be cut off from the block of food in order to obtain the target value for a portion is then calculated. For this, the scan values pᵢ are added until the desired target value has at least been reached (e.g. 375 scan slices). This corresponds to a real product length of 37.5 mm which needs to be cut off from the block of food for this portion.

6) Assuming that the portion is intended to have 15 food slices in the present case, a food slice thickness of 2.5 mm is obtained.

7) Accordingly, the slicing machine will cut off 15 food slices having a thickness of 2.5 mm each from the block of food.

8) Steps 5 to 7 are repeated until the block of food has been sliced.

### EXAMPLE 3

1) The length L of the block of food is measured (e.g. 500 mm). This is done using a photocell and encoder, for example, which measures the advance of the belt which holds the block of food for as long as the signal from the photocell is interrupted.

2) The block of food is transported through an X-ray scanner. The X-ray scanner takes a split shot of the block of food, e.g. every 0.1 mm. The width of the split is set by the speed at which the block of food passes through the X-ray scanner and/or the frequency of the shots, for example.

3) The X-ray scanner ascertains n=5000 data items, p_{i,i=1-n}, for example. The ascertained values p_{i,i=1-n} are dependent on the local X-ray absorption of the block of food and are p₁=83.234, p₂=83.334, p₃=83.244, for example. The values are stored individually and as a function of their position along the longitudinal axis of the block of food in a computer unit which is connected to the X-ray scanner.

4) All 5000 values are then added (e.g. 416325).

5) The target weight of the portion (e.g. 150 g) and a known average density are first of all taken as a basis for calculating what length lᵢ per portion (for example 50 mm) needs to be taken off and what measured value sum corresponds to this weight=416325*50/500. The number of scan slices which need to be cut off from the block of food in order to obtain the target value for a portion is then calculated. For this, the scan values pᵢ are added until the desired target value has at least been reached (e.g. 375 scan slices). This corresponds to a real product length of 37.5 mm which needs to be cut off from the block of food for this portion.

6) Assuming that the portion is intended to have 15 food slices in the present case, a food slice thickness of 2.5 mm is obtained.

7) Accordingly, the slicing machine will cut off 15 food slices having a thickness of 2.5 mm each from the block of food.

8) Steps 5-7 are repeated until the block of food has been sliced.

9) The real weight of the package can then be ascertained and the removed value of the density corrected if appropriate.

### EXAMPLE 4

1) The weight W of the block of food is ascertained (e.g.: 2000 g).

2) The block of food is transported through an X-ray scanner. The X-ray scanner takes a split shot of the block of food, e.g. every 0.1 mm. The width of the split is set by the speed at which the block of food passes through the X-ray scanner and/or the frequency of the shots, for example.

3) The X-ray scanner ascertains n=5000 data items, p_{i,i=1-n}, for example. The ascertained values p_{i,i=1-n} are dependent on the local X-ray absorption of the block of food and are p₁=83.234, p₂=83.334, p₃=83.244, for example. The values are stored individually and as a function of their position along the longitudinal axis of the block of food in a computer unit which is connected to the X-ray scanner.

4) The scan values are plotted as a curve p_{i,i=1-n} (x).

5) All 5000 values are then added (e.g. 416325) or the integral beneath the entire curve is calculated.

6) The target weight of the portion (e.g. 150 g) is taken as a basis for calculating an integral beneath the curve and calculating what length 1 needs to be taken off from the block of food for the respective portion. This calculation is preferably irrespective of the thickness of the scan slices.

7) Step 6 is repeated until the block of food has been completely split into portions.

8) The block of food is then sliced in accordance with the calculated guidelines.

### LIST OF REFERENCE SYMBOLS

1 Block of food
1′ Ends of the block of food
1″ Longitudinal axis of the block of food
2 Food slices
3 Portion
4 Sensor means, irradiation scanner
4′ Source, receiver
4″ Receiver, source
5 Means of transport in the scanner
6 Detection means
7 Start of the block of food
8 Measured value curve
9 Scan slice
10 Scales
11 Means of transport, conveyor belt
12 Slicer, slicing machine
13 Portioning belt
14 Cutting knife
15 Sensor/stop
16 Means of transport, conveyor belt in the slicer
17 Orientation means
18′-18″″ Peripheral face
19 Slicing line
20 Drive
21 Foreign body, bruise
22 Scan plane
L Length of the block of food
l Length of a portion
i Index of the respective scan slice, i=1−n
G Desired weight of the portion 3
h Interval between means of transport and detection means 6, 15
k Factor (k=W/P)
n Number of scan slices
N Number of slices cut per portion
P Sum of the measured signals, particularly pixels
pᵢ Measured signal from the individual scan slice
W Weight of the entire block of food
wᵢ Weight of the individual scan slice
xᵢ Thickness of the individual scan slice
x_{N} Thickness of the portion which has been cut off
α Physical interval between the detection means 6 of the and the reference point
β Reference point for the measurement
γ Interval between detection means and cutting knife
δ Interval between detection means and sensor means

1. A method for slicing a block of food into portions of precise weight, characterized in that:
a weight (W) or a length (L) of the block of food is ascertained,
an irradiation scanner ascertains n signals (p_{i,i=1-n}) from n scan slices having a thickness (x_{i,i=1-n}) which are arranged in succession along a longitudinal axis (x) of the block of food,
the signals (p_{i,i=1-n}) are stored in a computer unit and a sum thereof (P) is formed and stored,
the values of W, P and p_{i,i=1-n} or L, P and p_{i,i=1-n} and also a desired target weight G of a respective portion are used to calculate a length to be taken off (x_{N}) from the block of food, and
the length to be taken off is transferred to a slicing machine which cuts off the respective portion.

2. The method as claimed in claim 1, characterized in that the weight (wᵢ) of each scan slice is calculated and stored.

3. The method as claimed in claim 2, characterized in that the weight (wᵢ) of each scan slice is ascertained using the formula wᵢ=pᵢ*W/P.

4. The method as claimed in claim 2, characterized in that the values wᵢ are used to calculate a number of scan slices to be taken off

5. The method as claimed in claim 1, characterized in that a sum of a number of measured values to be taken off per respective portion is calculated.

6. The method as claimed in claim 5, characterized in that the sum of the number of measured values to be taken off per portion is ascertained using the formula G*P/W.

7. The method as claimed in claim 4, characterized in that the number of scan slices to be taken off is converted into the length to be taken off (x_{N}).

8. The method as claimed in claim 1, characterized in that the length to be taken off (x_{N}) is sliced into a prescribed number of food slices.

9. The method as claimed in claim 1, characterized in that the thickness of the respective slice is predetermined.

10. The method as claimed in claim 1, characterized in that detection means captures at least one reference point (β) from a start of the block of food on a conveyor belt and starts a recording of the measured values and/or a capture of an advance of a conveyor belt.

11. The method as claimed in claim 10, characterized in that a distance (α) between the reference point (β) and a scan plane is ascertained.

12. The method as claimed in claim 11, characterized in that the distance between the reference point and the scan plane (α) is transmitted to the slicing machine.

13. The method as claimed in claim 1, characterized in that a plurality of block of foods are at least intermittently irradiated simultaneously using the irradiation scanner.

14. The method as claimed in claim 13, characterized in that for each block of food a reference point (β) is ascertained and transmitted to the slicing machine individually.

15. A slicing machine having a cutting knife which takes off food slices from a front end of a block of food, wherein the block of food is transported by a means of transport in a direction of the cutting knife, and means to establish and track a position of the block of food on the means of transport in the direction of transport thereof.

16. The slicing machine as claimed in claim 15, characterized in that the means to establish and track comprises a sensor or a stop.

17. The slicing machine as claimed in claim 15, characterized in that the means of transport comprises an encoder.

18. The slicing machine as claimed in claim 15, comprises a plurality of means of transport, wherein each means of transport is provided with a means to establish and track the position of the block of food on the means of transport in the direction of transport thereof.

19. The slicing machine as claimed in claim 18, characterized in that the speed of transport of each means of transport can be set individually.

20. The slicing machine as claimed in claim 15, characterized in that the means to establish and track recognizes a start of the block of food.

21. The slicing machine as claimed in claim 20, characterized in that the means to establish and track captures the start of the block of food in the same region as an irradiation scanner.

22. The slicing machine as claimed in claim 15, comprises a means to establish an orientation of the block of food on the means of transport.

23. The slicing machine as claimed in claim 15, comprises a means to individualize the block of food.

24. The slicing machine as claimed in claim 23, comprises a controller which associates a scan data record with the block of food.

25. A block of food, comprising means to establish an orientation of the block of food.

26. The block of food as claimed in claim 25, characterized in that the means to establish establishes a position of a start of the block of food.

27. The block of food as claimed in claim 25, characterized in that the means to establish establishes a position of a face.
